(19) United States
(12) Patent Application Publication
(10) Pub. No.: US 2016/0351220 A1
(43) Pub. Date: Dec. 1, 2016

(54) MAGNETIC DISK DEVICE, CONTROL METHOD, AND MANUFACTURING METHOD OF MAGNETIC DISK DEVICE

(71) Applicant: Kabushiki Kaisha Toshiba, Tokyo (JP)

(72) Inventor: Satoshi Shibata, Fussa Tokyo (JP)

(21) Appl. No.: 14/842,080

(22) Filed: Sep. 1, 2015

Related U.S. Application Data
(60) Provisional application No. 62/168,507, filed on May 29, 2015.

(51) Int. Cl. G11B 5/596

(52) U.S. Cl. CPC G11B 5/59666; G11B 5/59627; G11B 5/59661

(57) ABSTRACT

According to one embodiment, a magnetic disk device includes a head including a read head and a write head, a disk including a plurality of tracks amounts of eccentricity of which periodically vary in a radial direction, and a controller configured to refer to information about the amounts of eccentricity in the radial direction, acquire a first amount of eccentricity at a first position of the read head at the time when data is written on a track, and a second amount of eccentricity at a second position of read head positioned at the track, calculate a difference value between the first amount and the second amount of eccentricity, and control the read head on the basis of the difference value and the information.

### CROSS-REFERENCE TO RELATED APPLICATIONS

This application claims the benefit of U.S. Provisional Application No. 62/168,507, filed May 29, 2015, the entire contents of which are incorporated herein by reference.

### FIELD

Embodiments described herein relate generally to a magnetic disk device, control method, and manufacturing method of magnetic disk device.

### BACKGROUND

There is a magnetic disk device configured to write a servo pattern to a disk by the self servo write method. In this magnetic disk device, in order to reduce a characteristic difference between adjacent spiral servo patterns, spiral servo patterns are written in a particular order in some cases. In this case, periodic variations occur sometimes in the spiral servo pattern in the amount of eccentricity at positions minutely different from each other in the radial direction of the disk. On the disk on which servo patterns are written on the basis of such spiral servo patterns at the time of manufacture, there is a possibility of the head following servo patterns having different amounts of eccentricity at the time of write and at the time of read. In this case, in the conventional offset correction of the read head and write head in the radial direction or in the dynamic offset correction based on the eccentricity of the disk, regarding the periodic variations in the amount of eccentricity at positions minutely different from each other in the radial direction of the disk, the track shape is considered to slowly change in the radial direction. However, in recent years, due to the densification of the track pitches, the possibility of the difference in the amount of eccentricity between write and read influencing the characteristics and performance at the time of read or at the time of write is raised.

### BRIEF DESCRIPTION OF THE DRAWINGS

FIG. 1 is a block diagram showing configuration of a magnetic disk device associated with a first embodiment;

FIG. 2A is a schematic view showing an example of a disk on which multi-spiral servo patterns are written;

FIG. 2B is a schematic view showing an example of servo patterns in the product stage;

FIG. 2C is a schematic view showing an example of the write order of the spiral servo patterns;

FIG. 3A is a schematic view showing an example of a measurement result of an amount of eccentricity slowly changing in the radial direction of the disk;

FIG. 3B is a schematic view showing an example of a measurement result of an amount of eccentricity of a case where the amount of eccentricity periodically varies in the radial direction of the disk;

FIG. 4A is a schematic view showing an example of track of a servo track in the measurement result of the amount of eccentricity shown in FIG. 3A;

FIG. 4B is a schematic view showing an example of track of a servo track in the measurement result of the amount of eccentricity shown in FIG. 3B;

FIG. 5A is a view showing an example of a case where the primary flicker of a read signal based on the track center is large;

FIG. 5B is a view showing an example of a case where the primary flicker of a read signal based on the track center is small;

FIG. 6A is a schematic view showing an example of state of the head of a case where a read/write gap offset does not occur;

FIG. 6B is a schematic view showing an example of state of the head of a case where a read/write gap offset occurs;

FIG. 7A is a view showing an example of a table of distribution of amounts of eccentricity because of write order of the spiral servo patterns;

FIG. 7B is a view obtained by enlarging a part of FIG. 7A;

FIG. 8 is a flowchart of an operation of the magnetic disk device in the manufacturing process;

FIG. 9 is a flowchart of a write operation of the magnetic disk device;

FIG. 10 is a flowchart of a read operation of the magnetic disk device; and

FIG. 11 is a flowchart showing an example of speed-enhanced processing of amount of eccentricity measurement of a second embodiment.

### DETAILED DESCRIPTION

In general, according to one embodiment, a magnetic disk device comprises: at least one head comprising a read head and a write head; at least one disk comprising a plurality of servo tracks amounts of eccentricity of which periodically vary in a radial direction of the disk; and a controller configured to refer to distribution information about the amounts of eccentricity of positions in the radial direction of the disk, the distribution information being acquired in advance, acquire a first amount of eccentricity at a first radial position of the read head at the time when data is written on a track of the disk by the write head, and a second amount of eccentricity at a second radial position of the read head at the time when the read head is positioned at the track, calculate a difference value between the first amount of eccentricity and the second amount of eccentricity, and control a position of the read head at the time of a read operation on the basis of the difference value and the distribution information.

Hereinafter, embodiments will be described with reference to the drawings.

### First Embodiment

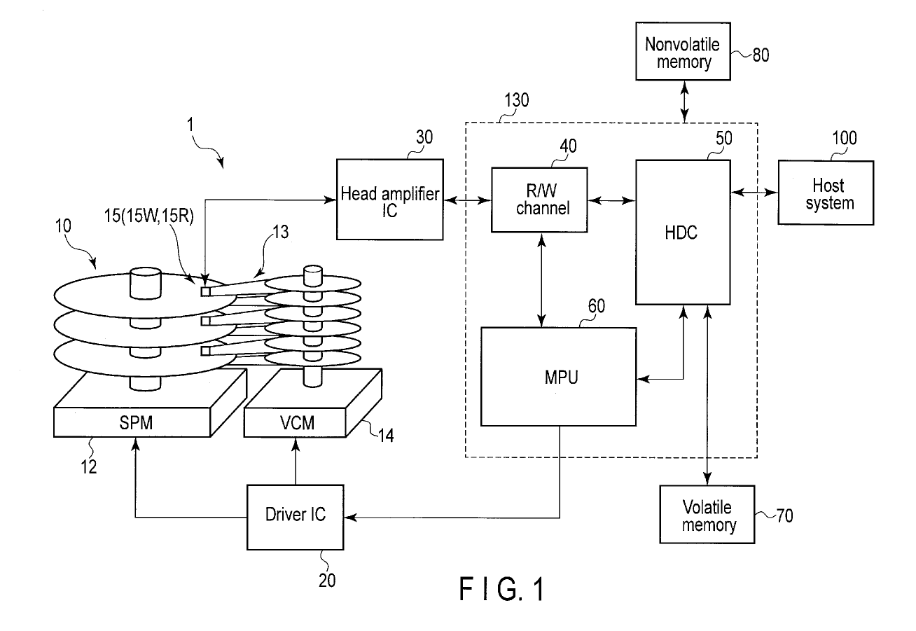

FIG. 1 is a block diagram showing configuration of a magnetic disk device associated with this embodiment.

A magnetic disk device 1 includes a head-disk assembly (HDA) to be described later, driver IC 20, head amplifier integrated circuit (hereinafter referred to as a head amplifier IC) 30, volatile memory 70, nonvolatile memory 80, and system controller 130 constituted of a one-chip integrated circuit. In the magnetic disk device 1, the system controller 130 is connected to each of the driver IC 20, the head amplifier IC 30, and volatile memory 70. Further, the magnetic disk device 1 is connected to a host system (host) 100.

The HDA includes a magnetic disk (hereinafter referred to as a disk) 10, spindle motor (SPM) 12, arm 13 on which a head 15 is mounted, and voice coil motor (VCM) 14. The disk 10 is rotated by the spindle motor 12. The arm 13 and the VCM 14 constitute an actuator. The actuator carries out control of movement of the head 15 mounted on the arm 13 to a particular position on the disk 10 by the drive of the VCM 14. One or more disks 10 and heads 15 may be provided.

The head 15 includes a slider serving as a main body, and read head 15R and write head 15W which are mounted on the slider. The read head 15R reads data recorded on the disk 10. The write head 15W writes data on the disk 10.

The driver IC 20 is connected to the SPM 12 and VCM 14, and controls drive of these members.

The head amplifier IC 30 includes a read amplifier and write amplifier which are not shown. The read amplifier amplifies a read signal read by the read head 15R, and transmits the amplified read signal to an R/W channel 40 included in the system controller 130. Further, the write amplifier transmits a write current corresponding to a write signal output from the R/W channel 40 to the write head 15W.

The volatile memory 70 is a semiconductor memory in which when supply of power is cut off, stored data is lost. The volatile memory 70 stores therein data and the like necessary for processing to be carried out in each section of the magnetic disk device 1. The volatile memory 70 is, for example, a synchronous dynamic random access memory (SDRAM).

The nonvolatile memory 80 is a semiconductor memory in which even when supply of power is cut off, stored data is maintained. The nonvolatile memory 80 is, for example, a flash read-only memory (ROM). The nonvolatile memory 80 is connected to the system controller 130.

The system controller 130 includes the aforementioned R/W channel 40, a hard disk controller (HDC) 50, and microprocessor (MPU) (controller) 60.

The R/W channel 40 executes signal processing of read data and write data. The R/W channel 40 executes decode processing of read data extracted from a read signal supplied from the head amplifier IC 30. The R/W channel 40 transfers the decode-processed read data to the HDC 50 and MPU 60. The read data includes user data and servo data. Further, the R/W channel 40 subjects write data transferred from the HDC 50 to code modulation to thereby convert the code-modulated write data into a write signal. The R/W channel 40 transfers the write signal to the head amplifier IC 30.

The HDC 50 controls data transfer between the host 100 and R/W channel 40 by utilizing a memory, for example, the volatile memory 70 or the like.

The MPU 60 is a main controller connected to each section of the magnetic disk device 1, and configured to control each section. The MPU 60 controls the VCM 14 through the driver IC 20, and executes servo control to carry out positioning of the head 15.

### (Write Method of Servo Pattern)

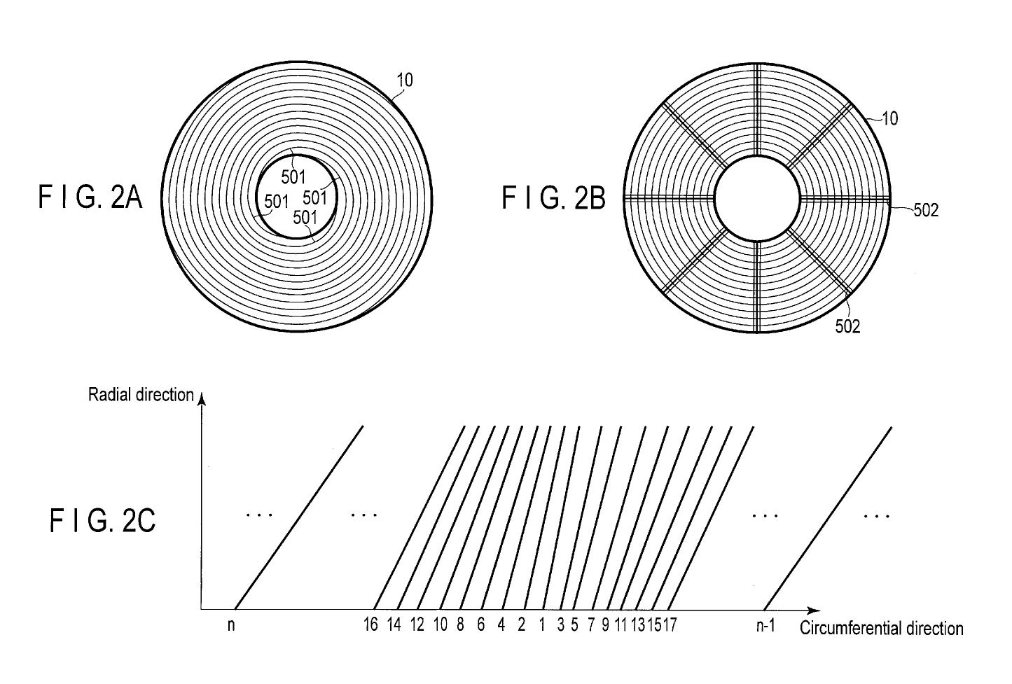

Hereinafter, an example of a self servo write (SSW) method to be employed by the magnetic disk device according to this embodiment will be described with reference to FIG. 2A, FIG. 2B, and FIG. 2C.

FIG. 2A is a schematic view showing an example of a disk on which a multi-spiral servo patterns are written. FIG. 2B is a schematic view showing an example of servo patterns in the product stage. In the servo write process at the time of manufacture, seed patterns (base patterns) are written to part of the inner circumference and/or outer circumference on the disk 10 by using a dedicated device (for example, a servo writer for each single disk plate [STW]). The disk 10 on which the seed patterns are written is incorporated in the magnetic disk device 1. The MPU 60 writes servo patterns of a spiral shape (hereinafter referred to as spiral servo patterns) 501 by using the write head 15W on the basis of the seed patterns written on the disk 10 incorporated in the magnetic disk device 1. At this time, the MPU 60 writes a plurality of spiral servo patterns (multi-spiral servo patterns) 501 in a particular order to be described later in order to minimize the interval variation between adjacent spiral servo patterns 501 (by suppressing the influence of thermal off-track or the like to the utmost). After the write of the multi-spiral servo patterns 501, the MPU 60 writes radiated final servo patterns (product servo patterns or final servo patterns) 502 as shown in FIG. 2B on the disk 10 by the SSW method by using the write head 15W on the basis of the multi-servo patterns 501.

It should be noted that in one example of the aforementioned SSW method, although it has been mentioned that the MPU 60 writes the spiral servo patterns 501 on the basis of the seed patterns, the spiral servo patterns 501 may be written without using the seed patterns.

FIG. 2C is a schematic view showing an example of the write order of the spiral servo patterns. In FIG. 2C, the ordinate represents the radial direction (track direction), and the abscissa represents the circumferential direction (sector direction). Further, numbers indicated on the abscissa show an example of order in which the spiral servo patterns 501 are written. As shown in FIG. 2C, the MPU 60 writes a first spiral servo pattern 501 on the disk 10. The MPU 60 writes a next (second) spiral servo pattern 501 at one of next positions on both sides of the spiral servo pattern 501 written first, and writes a third spiral servo pattern 501 at a position opposite to the second spiral servo pattern with the first spiral servo pattern 501 interposed in between. Thereafter, the MPU 60 continuously writes multi-spiral servo patterns 501 on the disk 10 up to an nth pattern in such a manner that the multi-spiral servo patterns alternately expand with the first spiral servo pattern 501 used as a point of reference. It is possible to make the interval variation between adjacent spiral servo patterns 501 small by writing spiral servo patterns 501 in the order by which the spiral servo patterns 501 alternately expand with the first spiral servo pattern 501 used as a point of reference as described above. When the spiral servo patterns 501 are written in such order, periodic variations may occur in the amount of disk eccentricity (hereinafter referred to as an amount of eccentricity) at positions (hereinafter referred to as minute radial positions) minutely different from each other in the radial direction of the disk 10. Here, the disk eccentricity implies deviation of the rotation center from the rotation axis caused by an impact which the magnetic disk device 1 receives from outside while starting or caused by incorporation or the like of the disk 10 into the magnetic disk device 1.

### (Degree of Eccentricity Attributable to Write Order of Spiral Servo Patterns)

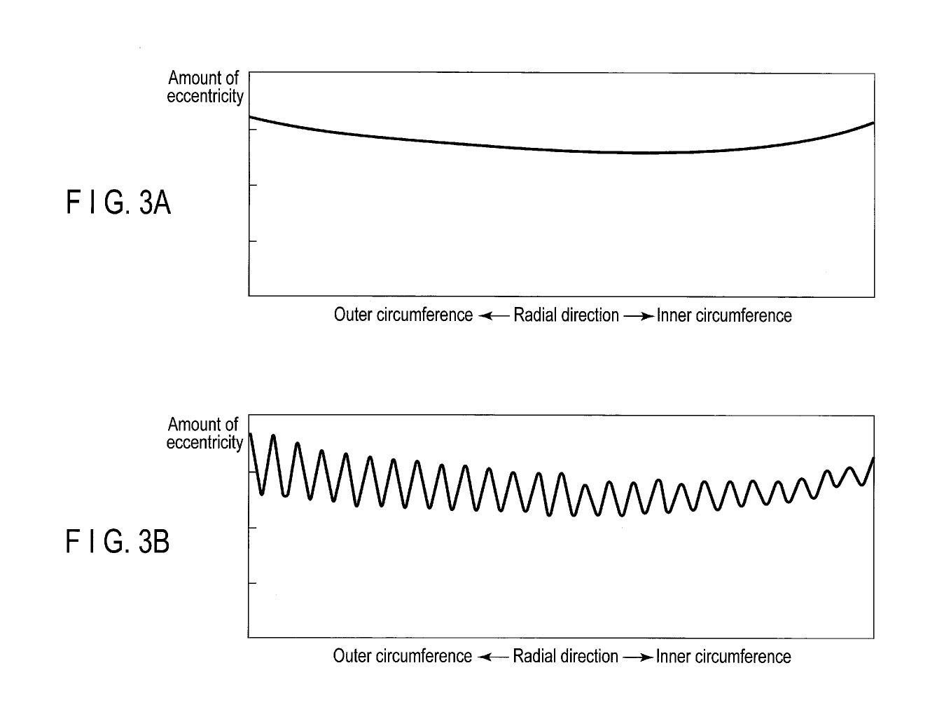

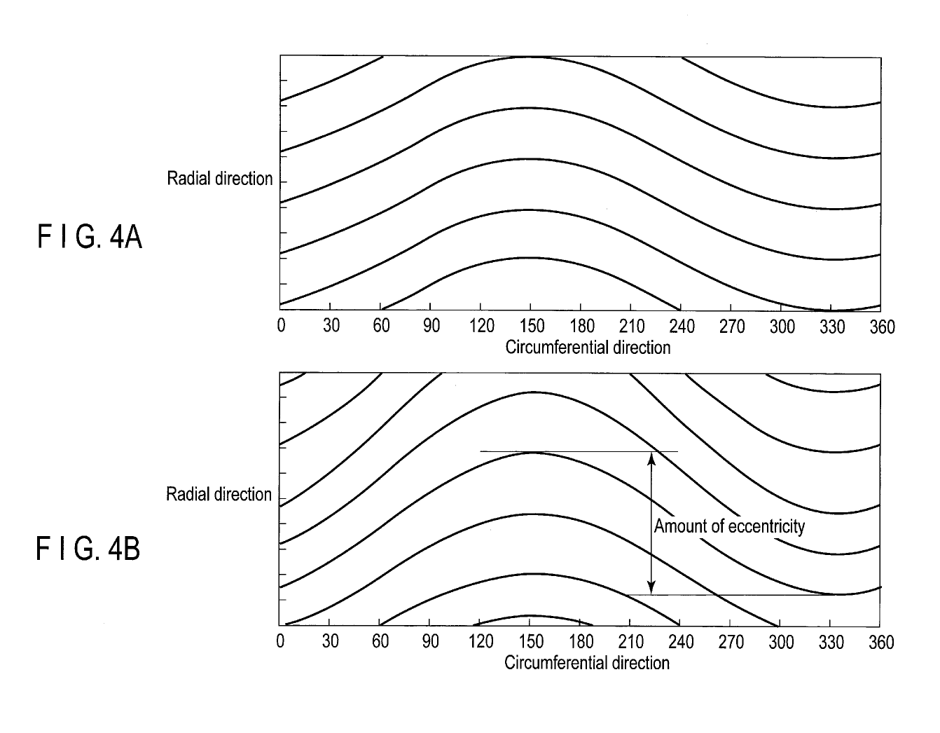

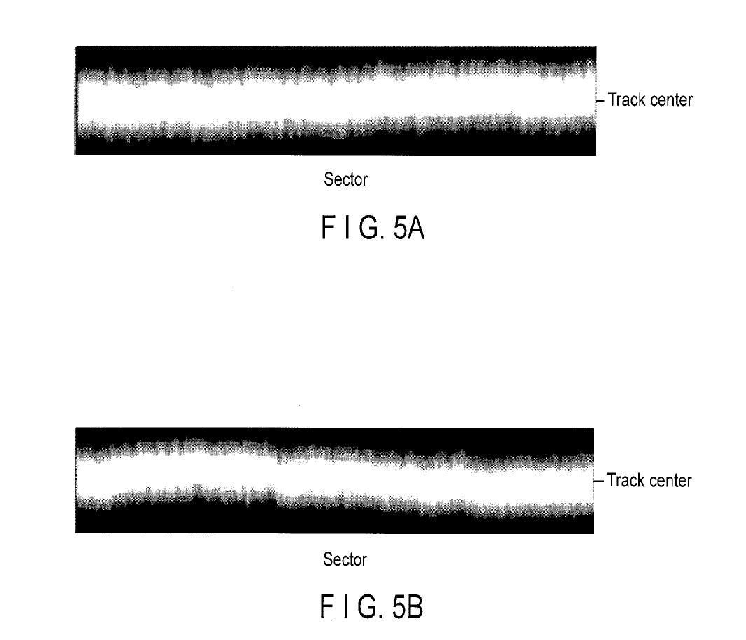

An amount of eccentricity attributable to the write order of the spiral servo patterns based on the SSW method will be described below with reference to FIG. 3A, FIG. 3B, FIG. 4A, FIG. 4B, FIG. 5A, and FIG. 5B.

FIG. 3A is a schematic view showing an example of a measurement result of an amount of eccentricity slowly changing in the radial direction of the disk 10, and FIG. 3B is a schematic view showing an example of a measurement result of an amount of eccentricity periodically varying in the radial direction of the disk 10. In FIG. 3A, and FIG. 3B, the ordinate represents the amount of eccentricity, and the abscissa represents the position on the disk 10 in the radial direction of the disk 10.

FIG. 3A shows an example of a measurement result of a primary amount of eccentricity of a final servo pattern of a case where the multi-spiral servo patterns are written by using a servo track writer (STW) or the like. FIG. 3B shows an example of a measurement result of a primary amount of eccentricity of a final servo pattern of a case where the multi-spiral servo patterns are written by the SSW method. As shown in FIG. 3B, when the multi-spiral servo patterns are written by the SSW method, the final servo pattern periodically varies in the radial direction in some cases.

FIG. 4A is a schematic view showing an example of track of a servo track in the measurement result of the amount of eccentricity shown in FIG. 3A, and FIG. 4B is a schematic view showing an example of track of a servo track in the measurement result of the amount of eccentricity shown in FIG. 3B. In FIG. 4A, and FIG. 4B, the ordinate represents the position in the radial direction of the disk 10, and the abscissa represents the position in the circumferential direction of the disk 10. In FIG. 4A, and FIG. 4B, the wavy sold lines indicate the shapes of the servo tracks. Here, the servo track is a track to be assumed when the servo sectors of the servo patterns are joined to each other in the circumferential direction. As shown in FIG. 3A, when the amount of eccentricity slowly changes in the radial direction on the disk 10, the shape of the servo track can be regarded as being identical at minute radial positions as shown in FIG. 4A. However, when the amount of eccentricity periodically varies at minute radial positions on the disk 10 as shown in FIG. 3B, the shape of the servo track varies at minute radial positions as shown in FIG. 4B.

FIG. 5A and FIG. 5B are views each showing an example of the primary flicker of a read signal based on the track center used as a point of reference. FIG. 5A shows an example of a read signal of a case where write data on the data track (hereinafter, simply referred to as a track or a cylinder) based on the shape of the servo track as shown in FIG. 4A is read, and FIG. 5B shows an example of a read signal of a case where write data on the track based on the shape of the servo track as shown in FIG. 4B is read. In FIG. 5A and FIG. 5B, the ordinate represents the Viterbi metric margin (VMM), and the abscissa represents the sector in the circumferential direction of the track. The VMM is a value obtained by counting the number of failures in branching of a pass memory in the R/W channel 40. By detecting the VMM, errors in the read data less than the error rate can be determined. In FIG. 5A and FIG. 5B, the track of the read operation of the head 15 is corrected by offset control (dynamic offset control [DOC]) of position-controlling by using an amount of variation of offset attributable to the disk eccentricity in one round of the track (circumferential direction) acquired in advance. It should be noted that in FIG. 5A and FIG. 5B, the light-colored part (white part) indicates that write data on the particular track has been read correctly, and the dark-colored part (black part) indicates that write data on the particular track has not been read correctly, i.e., that a read error has occurred.

In FIG. 5A, a primary flicker hardly occurs in the read signal (VMM), and hence the head 15 can correctly follow the write data. On the other hand, in FIG. 5B, a primary flicker occurs in the read signal, and hence there is a possibility of the head 15 being unable to follow the write data correctly in comparison with the case of FIG. 5A.

As described above, when the multi-spiral servo patterns are written in the particular order by the SSW method, it is necessary to take the variations in the amount of eccentricity at minute radial positions into consideration regarding a magnetic disk device of the high-density track pitches.

### (Structure of Head)

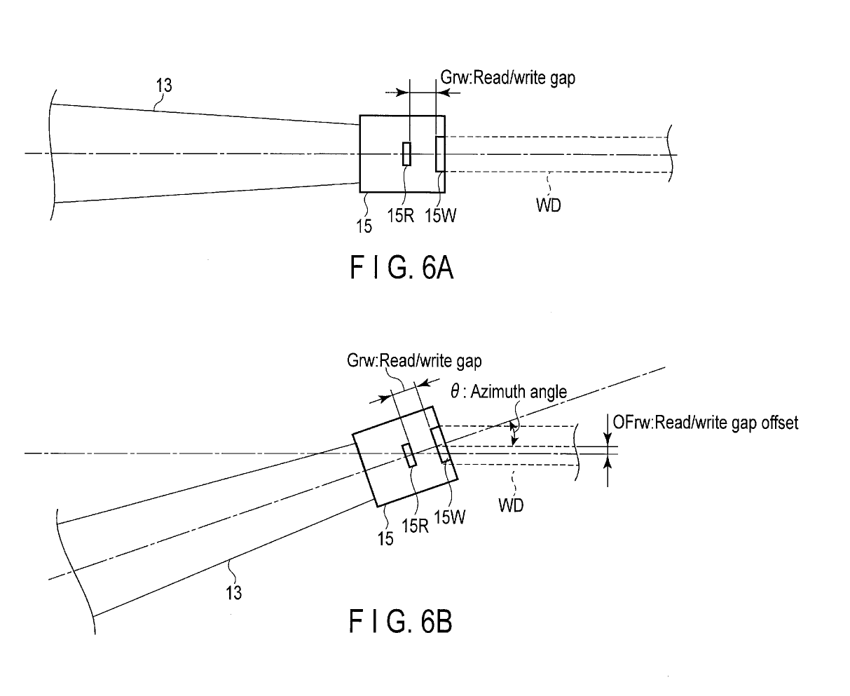

FIG. 6A is a schematic view showing an example of state of the head 15 of a case where a read/write gap offset does not occur. FIG. 6B is a schematic view showing an example of state of the head 15 of a case where a read/write gap offset occurs. As shown in FIG. 6A and FIG. 6B, the read head 15R, and the write head 15W are provided with a given interval (hereinafter referred to as a read/write gap Grw) held between them.

As shown in FIG. 6A, when the head 15 is arranged parallel to the magnetization direction of the write data WD on the write data WD, a read/write gap offset (position gap) hardly occurs between the tracks of the read head 15R and write head 15W.

On the other hand, as shown in FIG. 6B, when the head 15 is arranged inclined a particular angle (azimuth angle or skew angle) toward the magnetization direction of the write data WD on the write data WD, a read/write gap offset (hereinafter referred to as a read/write offset value) OFrw occurs between the tracks of the read head 15R and write head 15W. It should be noted that the azimuth angle changes depending on the track (cylinder) position at which the read operation or the write operation is executed, i.e., the position (hereinafter referred to as a radial position) in the radial direction on the disk 10. When the azimuth angle is θ degrees, the read/write offset value OFrw is expressed by the following equation (1).

OFrw=Grw×sin θ (1)

In the manufacturing process, the magnetic disk device 1 stores parameters used to calculate the read/write offset value OFrw in, for example, the nonvolatile memory 80 or the like. The parameters are values of, for example, an azimuth angle, read/write gap Grw, and the like at each position on the disk 10. It should be noted that the read/write offset value OFrw is irrelevant to the influence of the disk eccentricity.

### (Head Positioning Control)

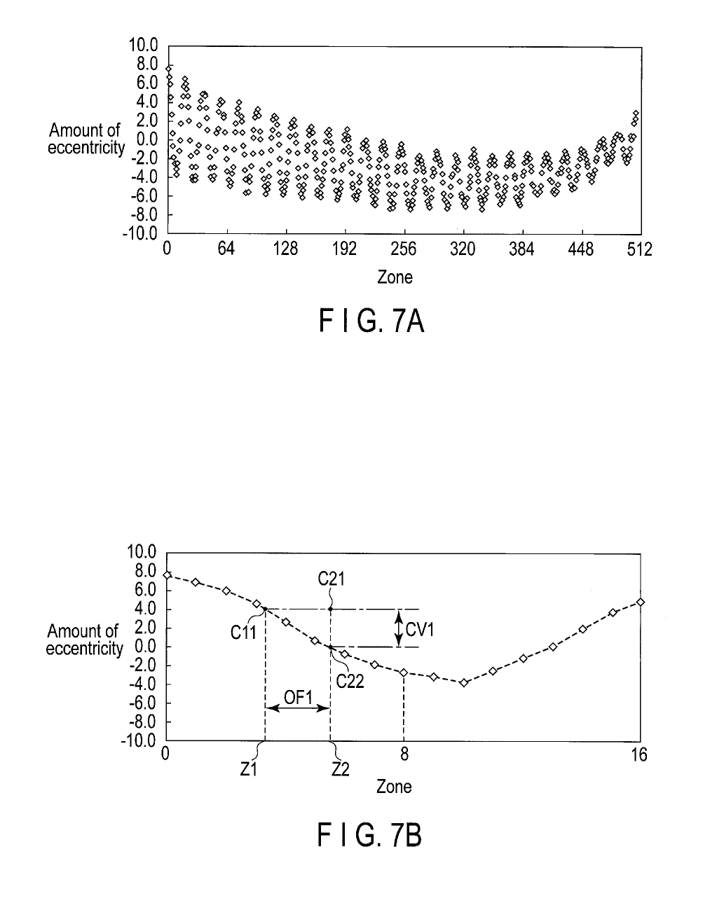

Next, a positioning operation of the head 15 taking the variation in the amount of eccentricity attributable to the write order of the spiral servo patterns based on the SSW method into consideration will be described below with reference to FIG. 7A and FIG. 7B. FIG. 7A is a view showing an example of a table of distribution information about amounts of eccentricity because of write order of the spiral servo patterns based on the SSW method, and FIG. 7B is a view obtained by enlarging a part of FIG. 7A. In FIG. 7B, the read/write offset value OFrw is shown as OF1. In FIG. 7A and FIG. 7B, the ordinate represents the amount of eccentricity, and the abscissa represents the zone of the disk 10 in the radial direction. Here, the zone includes a plurality of tracks. Further, in FIG. 7A and FIG. 7B, it is assumed that a plurality of tracks have been written on the disk 10 at high-density track pitches.

At the time of manufacture of the magnetic disk device 1, the MPU 60 measures in advance an amount of eccentricity for each zone (hereinafter referred to as a zone) formed by dividing the part on the disk 10 into minute sections in the radial direction. For example, as shown in FIG. 7A, the MPU 60 writes final servo patterns on the disk 10 in the manufacturing process, thereafter divides the part on the disk 10 into 512 zones, and measures the amount of eccentricity of each zone by fixing the read head to a particular radial position (with the control current fixed to a constant value). Here, the zone may be formed by dividing the part in accordance with the period of variation of the amount of eccentricity. The MPU 60 stores the measured amount of eccentricity for each zone in a storage medium as a table. For example, the MPU 60 stores a plurality of amounts of eccentricity measured in the 512 zones shown in FIG. 7A in the system area of the disk 10 or in the nonvolatile memory 80 as a table of discrete values. For example, the MPU 60 measures amounts of eccentricity a plurality of times on several tracks of each zone, and creates a table by making an average value of the measured plurality of amounts of eccentricity an amount of eccentricity in each zone. Further, the MPU 60 can complement a amount of eccentricity between adjacent zones by using the table of the plurality of discrete values of amounts of eccentricity on the basis of amounts of eccentricity of these adjacent zones.

It should be noted that although it has been mentioned that the part on the disk 10 is divided into a plurality of zones, and an amount of eccentricity is measured for each zone, the MPU 60 may measure an amount of eccentricity for each track (cylinder). In this case, the MPU 60 stores the measured amount of eccentricity for each track (cylinder) in the system area of the disk 10 or in the nonvolatile memory 80 as a table.

The MPU 60 executes positioning control of the head 15 by referring to the table. For example, the MPU 60 corrects the amount of eccentricity at the time of the read operation to thereby control the position of the read head 15R.

For example, as shown in FIG. 7B, when the read head 15R is positioned at a particular track in the radial direction (zone) Z1, the write head 15W is positioned at a track in the radial direction (zone) Z2 by the read/write offset value OF1. It should be noted that in FIG. 7B, the dynamic offset at each track is not taken into consideration for convenience of explanation. At this time, in order to follow the track at which the read head 15R has been positioned, the write head 15W writes data to zone Z2 on the track identical to zone Z1. That is, the write head 15W writes data to zone Z2 with an amount of eccentricity C21 equal to amount of eccentricity C11 of zone Z1. When the write data written to zone Z2 with amount of eccentricity C21 equal to amount of eccentricity C11 of zone Z1 is read, the read head 15R is positioned at a particular track of zone Z2 with amount of eccentricity C22 of zone Z2. At this time, a difference (eccentricity difference value) CV1 occurs between amount of eccentricity C11 of the position (zone Z1) of the read head 15R, and amount of eccentricity C22 of the position (zone Z2) of the write head 15W. For example, in FIG. 7B, the eccentricity difference value CV1 is 4.0.

For example, when a difference CV1 occurs between the amount of eccentricity of the position of the write head, and amount of eccentricity of the position of the read head at the time of the write operation, the MPU 60 acquires the amount of eccentricity (first amount of eccentricity) of the read head 15R by referring to the aforementioned table, and read/write offset value OF1. At this time, the MPU 60 can set a flag indicating that a difference occurs between the amounts of eccentricity. When the flag is set to the track at the time of the read operation, the MPU 60 acquires the amount of eccentricity (second amount of eccentricity) of the read head 15R by referring to the aforementioned table. The MPU 60 calculates an eccentricity difference value CV1, for example, 4.0 from the first amount of eccentricity and second amount of eccentricity. The MPU 60 controls the positioning of the read head 15R at the time of read on the basis of the eccentricity difference value CV1, for example, 4.0.

Substantially, a dynamic offset (DO) value occurs in each track in the circumferential direction according to the amount of eccentricity of the disk 10, and hence the MPU 60 calculates a correction value from the previously acquired dynamic offset (DO) value and eccentricity difference value of each track. The MPU 60 controls positioning of the read head 15R at the time of the read operation on the basis of the correction value.

### (Operation of Magnetic Disk Device)

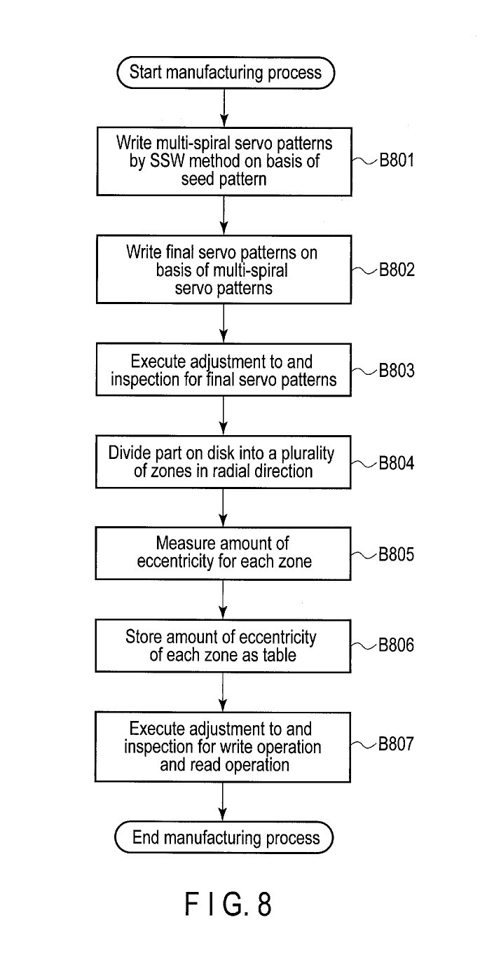

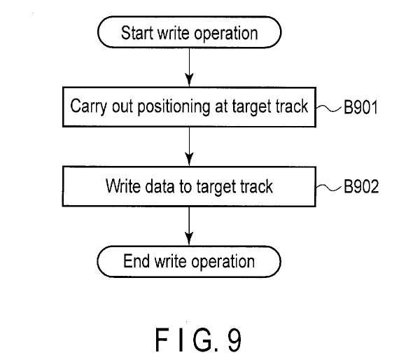

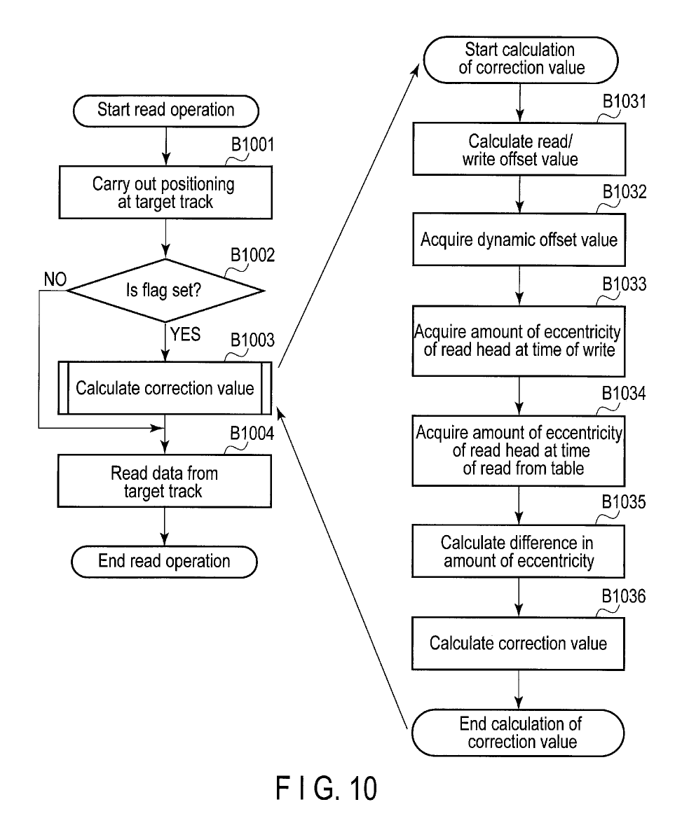

Next, the operation of the magnetic disk device according to the embodiment will be described below with reference to the flowcharts shown in FIG. 8, FIG. 9, and FIG. 10. It is assumed in these flowcharts, that after each processing operation has been executed, the flow advances from the executed processing to the next processing indicated by an arrow.

FIG. 8 is a flowchart of the operation of the magnetic disk device 1 in the manufacturing process. This FIG. 8 shows part of the manufacturing process of the magnetic disk device.

After the manufacturing process is started, in the middle of the particular process, the MPU 60 writes multi-spiral servo patterns on the disk 10 in the particular order by the self servo write (SSW) method on the basis of a seed pattern in B801.

In B802, the MPU 60 writes final servo patterns on the disk 10 on the basis of the multi-spiral servo patterns.

In B803, the MPU 60 executes an adjustment to and inspection for the final servo patterns.

In B804, the MPU 60 divides the part on the disk 10 into a plurality of zones in the radial direction.

In B805, the MPU 60 measures an amount of eccentricity for each zone.

In B806, the MPU 60 stores the distribution of the measured amounts of eccentricity of the zones in the storage medium in the magnetic disk device 1, for example, the system area of the disk 10 or the nonvolatile memory 80, and the like.

In B807, the MPU 60 executes an adjustment to and inspection for the write operation, and read operation, executes the other particular process and, thereafter the manufacturing process is terminated.

Next, the write operation and read operation of the magnetic disk device 1 will be described below.

FIG. 9 is a flowchart of the write operation of the magnetic disk device 1. In FIG. 9, in the magnetic disk device 1, final servo patterns have already been written on the disk 10 by the process shown in FIG. 8.

When the write operation is started, in B901, the MPU 60 positions the write head 15W at an objective target track on the basis of servo data. At this time, the read head 15R is positioned at a radial position different from the write head 15W owing to the skew angle in some cases. Accordingly, the write head 15W is positioned on the basis of the amount of eccentricity at the radial position of the read head 15R.

In B902, the MPU 60 writes data to the target track by using the write head 15W to thereby terminate the write operation. At this time, the MPU 60 may calculate a dynamic offset (DO) value for each sector, and write data to the target track on the basis of the DO value.

FIG. 10 is a flowchart of the read operation of the magnetic disk device 1. In FIG. 10, the magnetic disk device 1 writes write data on the disk 10 by the write operation shown in FIG. 9.

When the read operation is started, in B1001, the MPU 60 positions the read head 15R at the target track to which the data has been written by the write operation shown in FIG. 9.

In B1002, the MPU 60 determines whether or not a flag is set to the target track. When it is determined that no flag is set thereto (NO in B1002), the MPU 60 advances to the processing of B1004. When it is determined that a flag is set to the target track (YES in B1002), the MPU 60 executes processing of calculating a correction value in B1003.

In the calculation processing (B1003), first in B1031, the MPU 60 calculates a read/write offset value OFrw associated with the target track.

In B1032, the MPU 60 acquires a dynamic offset (DO) value at the target track.

In B1033, the MPU 60 reads the first amount of eccentricity acquired at the time of the write operation.

In B1034, the MPU 60 acquires an amount of eccentricity (second amount of eccentricity) of the read head 15R at the position of the target track to be read by referring to the table.

In B1035, the MPU 60 calculates an eccentricity difference value from the first amount of eccentricity acquired in B1033, and the second amount of eccentricity acquired in B1034.

In B1036, the MPU 60 calculates a correction value by adding the eccentricity difference value to the dynamic offset value of the target track at the time of the read operation. Here, the calculation processing of the correction value is terminated, and the flow advances to the processing of B1004.

In B1004, the MPU 60 executes positioning control of the read head 15R on the basis of the servo data read by the read head 15R, and the correction value calculated in B1036, and reads data from the target track. In this way, the read operation is terminated.

According to this embodiment, the magnetic disk device 1 stores therein distribution of amounts of eccentricity periodically varying at minute radial positions attributable to the multi-spiral servo patterns written by the SSW method as a table. The magnetic disk device 1 can control positioning of the head in such a manner that it is possible to follow an appropriate track both at the time of a write operation and at the time of a read operation with respect to a servo track having an amount of eccentricity periodically varying in the radial direction of the disk 10 by referring to this table. As a result, even when a read operation or a write operation is to be executed at higher-density track pitches on the basis of the servo patterns written by the SSW method, it is possible for the magnetic disk device 1 to reduce the reproduction error rate, and prevent the adjacent track from being adversely affected by the Adjacent Track Interference (ATI) resulting from the write.

It should be noted that the magnetic disk device 1 may be able to control positioning of the head 15 by using correction data for fluctuations (repeat run out [RRO]) synchronized with rotation due to eccentricity or the like of the disk 10. For example, the MPU 60 writes in advance a servo frame including a servo mark, track data indicating the track numbers, sector data indicating the number of servo data, burst data, RRO correction data based on the burst data, and the like at the head of a sector of each track. Here, the RRO correction data is data based on the burst data, and used to correct a steady misalignment between the track center and head position. When both the write RRO correction data, and read RRO correction data are provided, the MPU 60 can also control positioning of the read head 15R at the time of a read operation in the circumferential direction of each track on the basis of the read RRO correction data including amounts of eccentricity at minute radial positions. It is necessary to carry out write of the RRO correction data for each track.

Next, a modification example of the magnetic disk device according to the first embodiment will be described below. In the modification example of the embodiment, parts identical to the aforementioned first embodiment are denoted by identical reference symbols, and detailed descriptions of them are omitted.

### Modification Example

Although a magnetic disk device 1 of the modification example of the first embodiment has a configuration substantially identical to the first embodiment, the magnetic disk device 1 writes servo patterns by the bank write method.

In the magnetic disk device 1 of the modification example, the MPU 60 simultaneously writes multi-spiral servo patterns and final servo patterns on recording surfaces of a plurality of disks 10 by using a plurality of heads 15. Accordingly, a plurality of write heads 15W write multi-spiral servo patterns on writing surfaces other than a reference surface in order to follow the multi-spiral servo patterns written by a particular head 15 on a writing surface (hereinafter referred to as a reference surface) to be used as a point of reference among the plurality of disks 10.

That is, according to the modification example, the magnetic disk device 1 simultaneously writes multi-spiral servo patterns on recording surfaces of a plurality of disks 10 by the bank write method. The magnetic disk device 1 stores distribution of amounts of eccentricity at minute radial positions on the reference surface among the plurality of disks 10 as a table, whereby the magnetic disk device 1 can apply the table to control of positioning of the heads to the recording surfaces other than the reference surface. Accordingly, the magnetic disk device 1 can shorten the time required to measure amounts of eccentricity at minute radial positions for the plurality of disks 10.

Next, a magnetic disk device, and method of measurement according to another embodiment will be described below. In another embodiment, parts identical to the aforementioned embodiment are denoted by identical reference symbols, and detailed descriptions of them are omitted.

### Second Embodiment

Although a magnetic disk device 1 of a second embodiment has a configuration substantially identical to the aforementioned embodiment, the magnetic disk device 1 enhances the speed of measurement of the amounts of eccentricity by using a period of variation of an amount of eccentricity in the radial direction of the disk 10 of a case where the multi-spiral servo patterns are written by the SSW method.

In the magnetic disk device 1 of this embodiment, an MPU 60 acquires a wavy form (or period) of variation in the amount of eccentricity in the radial direction of the disk 10 on which multi-spiral servo patterns are written by the SSW method. Further, the MPU 60 selects a position in the radial direction of the disk 10 at which an amount of eccentricity is to be measured on the basis of the acquired period of variation. The MPU 60 executes measurement of an amount of eccentricity at only the selected position, and complements the amount of eccentricity of a radial position at which measurement is not carried out on the disk 10 on the basis of the measured amount of eccentricity and period of variation in the amount of eccentricity. The MPU 60 stores the distribution of the amounts of eccentricity acquired by complementing the unmeasured amounts of eccentricity in a storage medium, for example, a system area of the disk 10 or a nonvolatile memory 80 as a table. Further, in the sequence of servo write of multi-spiral servo patterns using the SSW method, the period of variation in the amount of eccentricity is uniquely determined, and hence the MPU 60 can carry out processing by regarding the period of variation in the amount of eccentricity as being unique as long as the sequence is not changed.

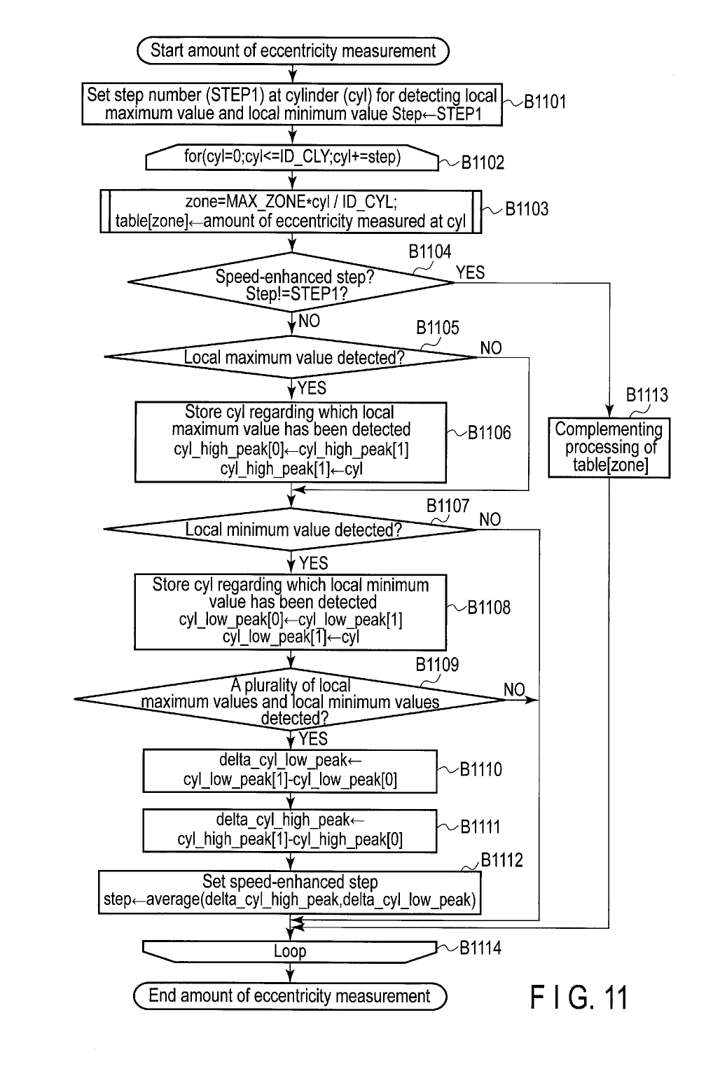

FIG. 11 is a flowchart showing an example of speed-enhanced processing of amount of eccentricity measurement of this embodiment.

When the amount of eccentricity measurement is started, in B1101, the MPU 60 sets a step number (STEP1) of a cylinder (track) number (cyl) to be measured for the purpose of detecting a local maximum value and local minimum value of amounts of eccentricity in the radial direction of the disk 10. Here, the cylinder number (cy1) to be measured for the purpose of detecting a local maximum value and local minimum value may be a value set in advance or may be a value to be arbitrarily set each time amount of eccentricity measurement is carried out. The step number (STEP1) is a value indicating an interval (or step) of the cylinder number (cy1) to be measured.

In B1102, the MPU 60 sets a condition, and starts loop processing. Here, the condition is as follows. cyl=0, cyl<=ID_CYL, cyl+=step

Here, cyl=0 indicates that the first cylinder number is 0. Further, ID_CYL is the maximum cylinder (track) number. Further, cyl+=step indicates that the sum of the cylinder number (cyl) and step number (step) be substituted for cyl.

As the loop processing of B1102, first in B1103, the MPU 60 inputs the amount of eccentricity measured at the cylinder number (cyl) to the table (table [zone]). The zone is calculated by calculating a ratio of the current cylinder number (cyl) to the maximum cylinder number (ID_CYL), and adding up the calculated ratios in the maximum zone number (MAX_ZONE). That is, the zone is calculated by zone=MAX_ZONE*cyl/ID_CYL. It should be noted that ID_CYL indicates the number of the last cylinder. Further, MAX_ZONE indicates the number of the last zone of the plurality of zones obtained by dividing the part on the disk 10 into zones. Further, MAX_ZONE is the zone number defined by, for example, the process shown in B804 of FIG. 8. It should be noted that amounts of eccentricity may be input to the table for each track (cylinder). In this case, the table is indicated by (table [cyl]). The MPU 60 inputs the amount of eccentricity measured by the cylinder number cyl to the table (table [cyl]).

In B1104, the MPU 60 determines whether or not step is different from STEP1 set in B1101. That is, the MPU 60 determines whether or not step is a speed-enhanced step. When it is determined that step is not speed-enhanced step (step and STEP1 are identical to each other) (NO in B1104), the MPU 60 determines in B1105 whether or not a local maximum value of amounts of eccentricity has been detected in the measured cylinder. On the other hand, when it is determined that step is speed-enhanced step (step and STEP1 are different from each other) (YES in B1104), the MPU 60 advances to the processing of B1113.

When it is determined in B1105 that the amount of eccentricity measured in the cylinder of the cylinder number (cyl) is a local maximum value (YES in B1105), the MPU 60 stores, in B1106, the cylinder number (cyl) regarding which the local maximum value of the amounts of eccentricity has been detected, and advances to the processing of B1107. When it is determined that the amount of eccentricity measured in the cylinder of the cylinder number (cyl) is not a local maximum value (NO in B1105), the MPU 60 skips the processing of B1106, and advances to the processing of B1107.

In B1107, the MPU 60 determines whether or not a local minimum value of amounts of eccentricity has been detected in the cylinder. When it is determined that the amount of eccentricity measured in the cylinder of the cylinder number (cyl) is a local minimum value (YES in B1107), the MPU 60 stores, in B1108, the cylinder number (cyl) regarding which the local minimum value of amounts of eccentricity has been detected. On the other hand, when it is determined that the amount of eccentricity measured in the cylinder of the cylinder number (cyl) is not a local minimum value (NO in B1107), the MPU 60 advances to the processing of B1114.

In B1109, the MPU 60 determines whether or not a plurality of, for example, two local maximum values of amounts of eccentricity, and two local minimum values of amounts of eccentricity have been detected. When it is determined that two local maximum values, and two local minimum values have been detected (YES in B1109), the MPU 60 calculates, in B1110, a value obtained by subtracting the cylinder number (cyl_low_peak[0]) of the second local minimum value detected one step earlier than the first local minimum value from the cylinder number (cyl_low_peak[1]) regarding which the first local minimum value has been detected as a difference value (delta_cyl_low_peak) between the cylinder numbers of the two local minimum values, and advances to the processing of B1111. When it is determined that two local maximum values, and two local minimum values have not been detected (NO in B1109), the MPU 60 advances to the processing of B1114.

In B1111, the MPU 60 calculates a value obtained by subtracting the cylinder number (cyl_high_peak[0]) of the second local maximum value detected one step earlier than the first local maximum value from the cylinder number (cyl_high_peak[1]) regarding which the first local maximum value has been detected as a difference value (delta_cyl_high_peak) between the cylinder numbers of the two local maximum values.

In B1112, the MPU 60 calculates an average value (average (delta_cyl_low_peak, delta_cyl_low_peak)) of the difference value (delta_cyl_low_peak) between the cylinder numbers of the local minimum values, and difference value (delta_cyl_high_peak) between the cylinder numbers of the local maximum values, sets the calculated average value to step as speed-enhanced step, and advances to the processing of B1114.

After returning to B1104, when it is determined that step is speed-enhanced step (YES in B1104), the MPU 60 calculates, in B1113, a plurality of cylinder numbers from which local maximum values and local minimum values can be detected from the average value, calculates a period of variation in the amount of eccentricity from the plurality of cylinder numbers, complements an amount of eccentricity of the table between the currently measured zone (zone[cyl]) and zone (zone(cyl-step)) measured one step earlier than the currently measured zone by referring to the period, and advances to the processing of B1114.

In B1114, the MPU 60 repeats the processing from B1102 to B1113 until the condition of B1102 is satisfied and, when the condition of B1102 is satisfied, terminates the measurement of amounts of eccentricity.

According to this embodiment, the magnetic disk device 1 detects local maximum values and local minimum values of amounts of eccentricity, calculates a period of variation in the amount of eccentricity from the position in the radial direction of the disk 10 at which the local maximum value and local minimum values have been detected, and can selectively measure amounts of eccentricity at only the radial position at which the local maximum values and the local minimum values are detected by referring to the calculated period. As a result, the magnetic disk device 1 need not measure amounts of eccentricity of all zones or cylinders, and the measurement time of amounts of eccentricity can be reduced.

According to the aforementioned embodiments, the magnetic disk device 1 stores the distribution of amounts of eccentricity in the radial direction attributable to the multi-spiral servo patterns written by the SSW method as a table. The magnetic disk device 1 can control positioning of the head even in the case of amounts of eccentricity periodically varying at minute radial positions, in such a manner that it is possible to follow an equal track both at the time of a write operation and at the time of a read operation. As a result, in the case where the multi-spiral servo patterns are written by the SSW method, and the track pitches are high-density track pitches, the magnetic disk device 1 can reduce reproduction error rate, and prevent the adjacent track from being adversely affected by the adjacent track interference (ATI) resulting from write.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
at least one head comprising a read head and a write head;
at least one disk comprising a plurality of servo tracks amounts of eccentricity of which periodically vary in a radial direction of the disk; and
a controller configured to refer to distribution information about the amounts of eccentricity of positions in the radial direction of the disk, the distribution information being acquired in advance,
acquire a first amount of eccentricity at a first radial position of the read head at the time when data is written on a track of the disk by the write head, and a second amount of eccentricity at a second radial position of the read head at the time when the read head is positioned at the track,
calculate a difference value between the first amount of eccentricity and the second amount of eccentricity, and
control a position of the read head at the time of a read operation on the basis of the difference value and the distribution information.

2. The magnetic disk device of claim 1, further comprising a nonvolatile memory, wherein
the controller measures the amount of eccentricity for each radial positions of the disk in advance, and stores the measured amount of eccentricity for each radial positions in the disk or in the nonvolatile memory as the distribution information.

3. The magnetic disk device of claim 2, wherein
the controller divides the disk into a plurality of zones in the radial direction, and measures the amount of eccentricity for each of the plurality of zones.

4. The magnetic disk device of claim 2, wherein
the controller measures the amount of eccentricity for each of the plurality of tracks of the disk.

5. The magnetic disk device of claim 2, wherein
the controller measures a dynamic offset at each of the plurality of tracks in advance, and adds the difference value to the dynamic offset to thereby control the position of the read head.

6. The magnetic disk device of claim 1, wherein
on the disk, a plurality of spiral servo patterns with different amounts of eccentricity are written from a center of the disk toward the outside, and the plurality of servo tracks are written according to the plurality of spiral servo patterns by a method of self servo write.

7. The magnetic disk device of claim 1, wherein
on the disk, a first spiral servo pattern is written first, a second spiral servo pattern is written at one of positions on both sides of the first spiral servo pattern, a third spiral servo pattern is written on the opposite side of the position at which the second spiral servo pattern has been written with the first spiral servo pattern interposed in between, a plurality of spiral servo patterns are alternately written with the first spiral servo pattern used as a point of reference, and the plurality of servo tracks are written according to the plurality of spiral servo patterns by the self servo write method.

8. The magnetic disk device of claim 1, further comprising a nonvolatile memory, wherein
the controller measures the plurality of amounts of eccentricity in a first zone in the radial direction of the disk, detects a plurality of local maximum values and a plurality of local minimum values of variation in the amount of eccentricity from the plurality of measured amounts of eccentricity, estimates a period of variation in the amount of eccentricity from the position in the radial direction at which the plurality of local maximum values and the plurality of local minimum values have been detected, measures amounts of eccentricity in a second zone in the radial direction of the disk other than the first zone, and including a local maximum value or a local minimum value of variation in the amount of eccentricity by referring to the estimated period, complements an amount of eccentricity in a zone of the disk between the first zone and the second zone, and stores distribution information about the amounts of eccentricity including the plurality of amounts of eccentricity of the first zone and the second zone obtained by the measurement, and the amount of eccentricity of the zone of the disk between the first zone and the second zone obtained by the complementing operation in the disk or in the nonvolatile memory.

9. The magnetic disk device of claim 8, wherein
when the local maximum values and the local minimum values are respectively detected at two positions, the controller estimates the period from the two local maximum values and the two local minimum values.

10. A control method of a head position to be applied to a magnetic disk device comprising at least one head including a read head and a write head, and at least one disk including a plurality of servo tracks amounts of eccentricity of which periodically vary in a radial direction of the disk, the control method comprising:
referring to distribution information about amounts of eccentricity of positions in the radial direction of the disk, the distribution information being acquired in advance;
acquiring a first amount of eccentricity at a first radial position of the read head at the time when data is written on a track of the disk by the write head, and a second amount of eccentricity at a second radial position of the read head at the time when the read head is positioned at the track;
calculating a difference value between the first amount of eccentricity and the second amount of eccentricity; and
controlling a position of the read head at the time of a read operation on the basis of the difference value and the distribution information.

11. The control method of claim 10, further comprising:
measuring the amount of eccentricity for each radial positions of the disk in advance; and
storing the measured amount of eccentricity for each radial positions as the distribution information.

12. The control method of claim 11, further comprising:
dividing the disk into a plurality of zones in the radial direction; and
measuring the amount of eccentricity for each of the plurality of zones.

13. The control method of claim 11, further comprising measuring the amount of eccentricity for each of the plurality of tracks of the disk.

14. The control method of claim 11, further comprising:
measuring a dynamic offset at each of the plurality of tracks in advance; and
adding the difference value to the dynamic offset to thereby control the position of the read head.

15. The control method of claim 10, further comprising:
writing a plurality of spiral servo patterns with different amounts of eccentricity from a center of the disk toward the outside; and
writing the plurality of servo tracks according to the plurality of spiral servo patterns by a method of self servo write.

16. The control method of claim 10, further comprising:
writing a first spiral servo pattern first;
writing a second spiral servo pattern at one of positions on both sides of the first spiral servo pattern;
writing a third spiral servo pattern on the opposite side of the position at which the second spiral servo pattern has been written with the first spiral servo pattern interposed in between;
writing a plurality of spiral servo patterns alternately by using the first spiral servo pattern as a point of reference; and
writing the plurality of servo tracks according to the plurality of spiral servo patterns by the self servo write method.

17. The control method of claim 10, further comprising:
measuring the plurality of amounts of eccentricity at part of the disk in the radial direction of the disk;
detecting a plurality of local maximum values and a plurality of local minimum values of variation in the amount of eccentricity from the plurality of measured amounts of eccentricity;
estimating a period of variation in the amount of eccentricity from the position in the radial direction at which the plurality of local maximum values and the plurality of local minimum values have been detected;
measuring amounts of eccentricity in a second zone in the radial direction of the disk other than a first zone, and including a local maximum value or a local minimum value of variation in the amount of eccentricity by referring to the estimated period;
complementing an amount of eccentricity in a zone of the disk between the first zone and the second zone; and
storing distribution information about the amounts of eccentricity including the plurality of amounts of eccentricity of the first zone and the second zone obtained by the measurement, and the amount of eccentricity of the zone of the disk between the first zone and the second zone obtained by the complementing operation.

18. The control method of claim 17, further comprising estimating, when the local maximum values and the local minimum values are respectively detected at two positions, the period of variation from the two local maximum values and the two local minimum values.

19. A manufacturing method of a magnetic disk device comprising at least one disk, and a nonvolatile memory comprising:
writing a plurality of spiral servo patterns with different amounts of eccentricity from a center of the disk toward the outside;
writing servo tracks on the disk according to the plurality of spiral servo patterns;
measuring the amount of eccentricity in advance for each radial positions of the disk; and
storing the measured amount of eccentricity for each radial positions in the disk or in the nonvolatile memory.

20. The manufacturing method of claim 19, further comprising:
writing the plurality of spiral servo patterns on a surface of at least the one disk on the basis of a reference surface of at least the one disk; and
measuring in advance the amount of eccentricity for each radial position on only the reference surface.
